(19) United States
(12) Patent Application Publication
(10) Pub. No.: US 2013/0340507 A1
(43) Pub. Date: Dec. 26, 2013

(54) MEASURING VISCOSITY OF CERAMIC SLURRIES

(71) Applicants: David A. Brookfield, Sharon, MA (US); Steven Cicchese, Bridgewater, MA (US); Joseph F. Murray, Bridgewater, MA (US)

(72) Inventors: David A. Brookfield, Sharon, MA (US); Steven Cicchese, Bridgewater, MA (US); Joseph F. Murray, Bridgewater, MA (US)

(73) Assignee: BROOKFIELD ENGINEERING LABORATORIES INC., Middleboro, MA (US)

(21) Appl. No.: 13/527,769

(22) Filed: Jun. 20, 2012

(51) Int. Cl. G01N 11/16

(52) U.S. Cl. 73/54.25; 73/54.24

(57) ABSTRACT

A viscosity measuring instrument for measuring ceramic slurries, e.g. in a casting tank, with a probe having an elbow and presenting a transducer part in substantial alignment with a flow direction of the ceramic slurry relative to the active part and a barrier orthogonal to such relative movement direction is interposed in front of the transducer part by one or more stand-off rods to form a partial enclosure that moderates flow to the active part and provides a long term stable measuring capability.

### FIELD AND BACKGROUND OF THE INVENTION

The present invention relates to measuring viscosity of ceramic slurries with usage for quality control of ceramic casting processes and myriad other usages in research and development and/or quality control.

Ceramic slurries in flowing conduits and static tanks have many usages including provision of material for “casting” by coating substrate parts immersed in the slurry. Such coating can be done in single or multiple stages, the latter often including a first encapsulating stage with high precision control of coating thickness and density. Later coating stages also require such control. The substrate parts can be permanent or removable after coating and solidification to leave the coating as a free standing part (investment casting). Complex substrate surface geometries and internal reentrant surfaces can be controllably coated. Ceramic casting presents special challenges of achieving reliable slurry characteristics and measuring them reliably, including measuring viscosity for its own sake and as a measure of other characteristics. After coating the ceramic parts are fired to attain ultimate strength, dimensions and morphology as finished products. Yields of usable products are dependent on reliable coating.

Viscosity and other characteristics relatable to it (e.g. shear rate and weight percent of solids) vary with depth in a tank containing substantial amounts of ceramic slurry, conditions of movement of slurry (generally induced to maintain homogeneity), capture by cast parts and replenishment or adjustment. There are several approaches to measuring viscosity—sometimes by extracting samples for viscosity measurements off-line and sometimes in situ through instrument probes inserted into the casting bath to various depths. The immersed probes have been vulnerable to drift and error over the course of casting operations and some may need frequent removal, cleaning or replacement, down time and recalibration of the probes and instruments. Some probes can be cleaned in situ without removal from the tank but are subject to undesireable and variable coating of transducer elements.

It is the object of the invention to provide an effective adjustment of the process and apparatus for viscosity measurement substantially mitigating such problems and optimizing thickness, increasing yields and enabling longer durations of casting process with minimal instrument related interruptions with reliable and predictable response to viscosity variations.

### SUMMARY OF THE INVENTION

The objects of the invention are met by a system that operates in a linear or rotational smooth flow of reduced turbulence of ceramic slurry, preferably through a cylindrical portion of an otherwise turbulent mixing regimen doing so in a cylindrical or toroidal chamber. An immersed probe extends vertically into the slurry with a turn of the probe end essentially orthogonal to the vertical probe, i.e. horizontal. The horizontal end of the probe faces the flow of slurry but is protected from it by a baffle or other barrier in front of the probe end, but spaced from it, to let the slurry work around the barrier and contact an active horizontal probe end, usually of rod or wire form. The probe rod is part of a vibrational transducer system for viscosity measurement, but the transducer can be of other mechanical, electrical, magnetic or acoustic formats.

As used herein, “horizontal” and “vertical” are defined as within plus or minus 45 degrees variation from true horizontal or vertical but preferably within plus or minus ten degrees or even five degrees for many applications. The horizontal probe assembly is movable over a significant depth range to take a series of measurements at different depths since viscosity of the slurry can vary substantially with depth end means for raising or lowering the probe as a whole, or at least its turned end, are provided. Means are also provided to rotate the probe or at least at its end within a horizontal plane or nearly so, i.e. with a plus or minus 45 degree range, preferably plus or minus 10 degrees or less to achieve substantially linear alignment of a transducer portion with the local slurry flow direction.

Typically the slurry is in a rotating tank that has internal fixed paddles to create a general mixing but with a rotational flow components Alternatively, rotatable paddles can be used within a fixed or rotating tank.

The baffle or other barrier in front of the probe end assembly may have holes or edge designs to optimize bringing the flow to the transducer within the probe end while mitigating against heavy probe coating or erratic flow.

The baffle or other barrier is spaced from the end of the probe end by rods or other means allowing a substantial flow horizontally and/or vertically through the spaces therebetween, but these will provide a protective function for the probe as well as stand-off supports for the baffle.

The transducer can be an ultrasonic rod form electrode mounted within a cage of several electronically/acoustically neutral rods for stand-off spacing the barrier from the instrument and forming a protective cage.

Ceramic slurry easily passes to/from the electrode without solid build up on the active part or surrounding structure of the vibrating probe.

The vibrating electrode probe instrument may be substantially as in the state of the art presented by the Brookfield Advanced Sensor Technology (AST-100) product. Vibrating at resonant frequency (typically 1-5 kilohertz) (preferably tuned to under 1 kilohert for slurry casting), it provides cyclic torsional drive control, then cyclically paused to measure a relaxation response which is electromagnetically measured and correlated to a relative or absolute viscosity and tuneable to a range of 2 to 12,500 centipoise (but which can be displayed in other scales, e.g. milliPascals), operating in a temperature range of −20° C. to +200° C.

Other objects, features and advantages will be apparent from the following detailed description of preferred embodiments taken in conjunction with the accompanying drawings in which:

### BRIEF DESCRIPTION OF THE DRAWINGS

FIG. 1 is a schematic rendering of a ceramic casting tank with an inserted viscosity measuring probe;

FIGS. 2-4 are side, top and isometric views of a modified probe in accordance with an embodiment of the present invention showing its probe end essentially via a flow direct or of the ceramic slurry.

### DETAILED DESCRIPTION OF PREFERRED EMBODIMENTS

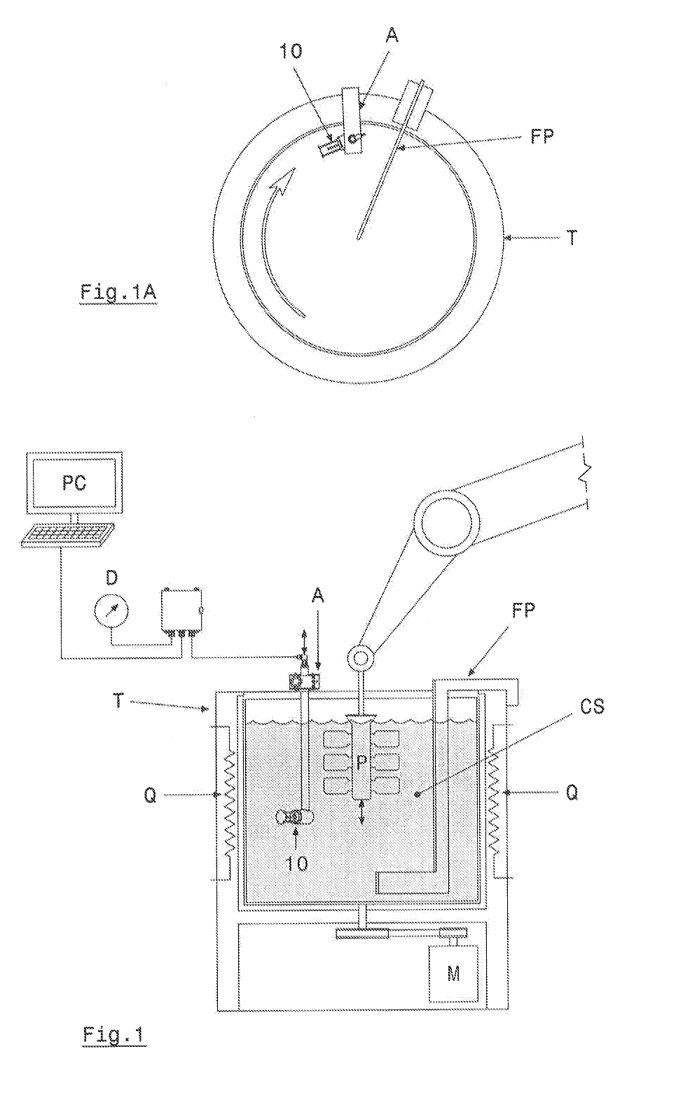

FIG. 1 shows schematically a casting tank T for ceramic slurry (casting) with a rotating drive motor M and heaters Q and fixed paddles FP to gain upward or downward flow of ceramic slurry CS in the tank. The casting is done on inserted parts on external surfaces (and reentrant internal surfaces). The parts P are lowered and withdrawn after casting. The parts can be permanent armatures (substrate) or temporary forms (made of wax or foam) which can be removed by heating or other means after coating in the tank, withdrawal and cooling or after firing the ceramic parts. Instead of rotating the tank internal paddles (IP) can be provided that are driven by an external motor with a shaft inserted from above.

The ceramic slurry in the tank is subject to partly predictable, partly unpredictable changes with height in the tank and other factors (e.g. sedimentation or agglomeration affected by ceramic compositions), particle average size and size distribution and morphology. A viscometer probe 10 is inserted and can be lowered and raised manually or by an actuator A to take readings at various heights and transmit data to an instrument for reading at a visual display D or digital recorder and the signal provided to a process controller PC to modify tank conditions and part P lowering/raising.

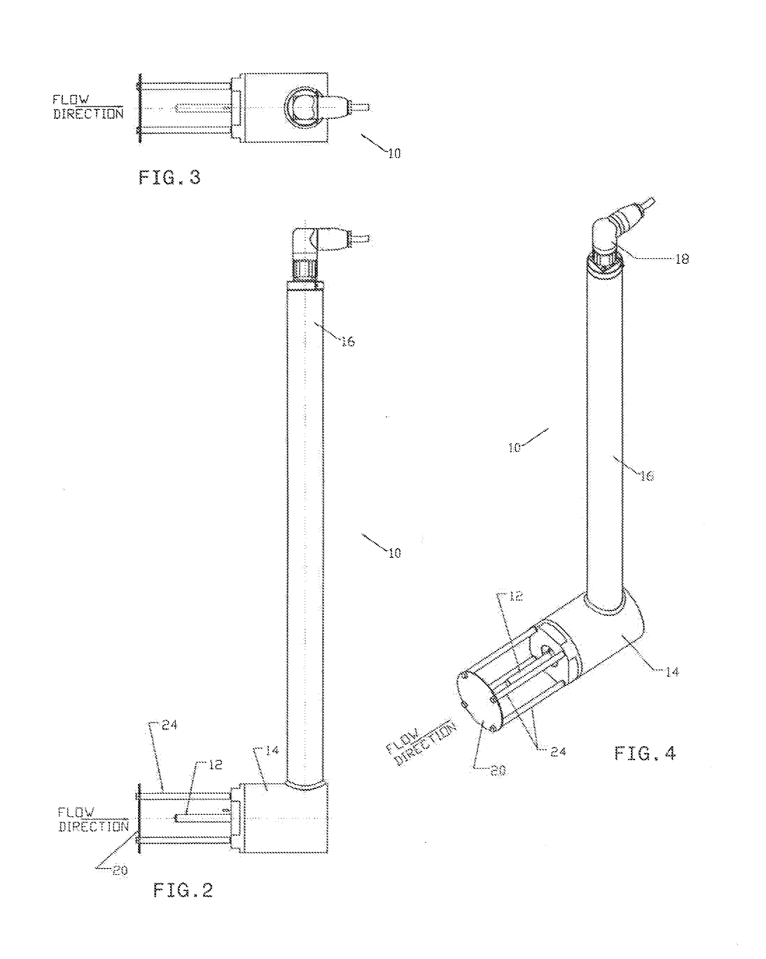

FIGS. 2-4 show side, top and isometric views of the viscometer probe 10. The probe has a sensor rod 12 (typically stainless steel) extending from a housing 14 containing a vibratory mechanism (e.g. torsionally rotating) to vibrate the rod 12 at high frequencies and pick up response of the rod to a ceramic around it (e.g. by intermittently driving it and terminating drive to pick up signal between drive cycles or by measuring/driving simultaneously using phase separation or other techniques known per se). Signal is transmitted via wiring in a cylindrical arm 16 and an elbow connection 18 to external reading/recording and/or process control means. The instrument probe and its external complement as described so far can be a Brookfield Engineering Laboratories Model AST-100 instrument. But other instruments with other transducer and control/measurement strategies for the in situ probe can be employed using the probe end constructions of the present invention. Other materials of parts exposed to the bath can be employed including refractory metals, superalloys and ceramics used per se or as coatings.

The probe has a baffle 22 supported ahead of the end of the sensor rod 12 by multiple rods 24 (typically stainless steel). The rod 12 is oriented essentially parallel to flow in the tank region of the probe end (typically circumferential flow in a cylindrical tank), within plus or minus 45 degrees, preferably in the plus or minus ten degrees range and the shield, which can be flat, conical or domed or other shapes is essentially orthogonal to the flow with plus or minus 45 degrees preferably within plus or minus ten degrees.

We have discovered that this orientation can provide a remarkable improvement in stability of the measuring process and make it effective over long periods of process operation operating at a single depth or over a range of depths in the tank.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A viscosity measuring instrument for use in measurement of viscosity of ceramic slurries comprising:
means defining an instrument with a transducer portion constructed and arranged for immersion into and movement within a vessel containing the slurry to present a portion of the transducer in substantially linear opposition to movement relative to the slurry for a continuous time range of contact and positioned to block direct flow of the slurry at the transducer along the direction of rotating movement of slurry,
the transducer being of a linear form substantially aligned with the direction of relative movement, and
means defining a barrier substantially orthogonal to the direction of relative movement, the barrier being held out from the transducer by one or more stand-off parts, the combination of barrier and stand-off being constructed and arranged to effect a tortuous path of slurry to the transducer and limit build up of coating on the transducer end.

2. The viscometer measuring instrument of claim 1 wherein the transducer is provided at the end of a probe vertically insertable into a vessel containing the ceramic slurry at various depths and having an end that orients the transducer to a horizontal direction of alignment with local flow of the ceramic slurry.

3. The viscometer measuring instrument of claim 2 wherein the probe end is essentially an elbow bend with the transducer comprising sensor at the end such as a rod, wire or cylinders, with external power source and response measuring means to excite the active part and derive a viscosity relatable response by measuring relaxation of the active part and/or power requirement for the excitation and the barrier is a flat or bent plate protecting the active part from direct linear contact and the plate is held out by one or more stand-off parts forming a partial enclosure of the active part that allows a moderated portion of slurry to reach the active part interact with it and relatively move on with minimal, if any, build up of coating of the active part.

4. The viscometer measuring instrument of claim 1 in combination with an external power supply and measuring and control system.

5. The viscometer measuring instrument of claim 1 in combination with means for creating slurry movement within a vessel containing it.
